(19) United States
(12) Patent Application Publication
(10) Pub. No.: US 2025/0348460 A1
(43) Pub. Date: Nov. 13, 2025

(54) INFORMATION PROCESSING APPARATUS AND INFORMATION PROCESSING METHOD

(71) Applicant: Fujitsu Limited, Kawasaki-shi (JP)

(72) Inventor: Hirokazu IWAKURA, Adachi (JP)

(73) Assignee: Fujitsu Limited, Kawasaki-shi (JP)

(21) Appl. No.: 19/175,479

(22) Filed: Apr. 10, 2025

(30) Foreign Application Priority Data
May 13, 2024 (JP) 2024-077644

(51) Int. Cl. G06F 15/80; G06F 9/50

(52) U.S. Cl. CPC G06F 15/80; G06F 9/5027; G06F 2209/5012

(57) ABSTRACT

An information processing apparatus includes a plurality of physical CPUs and a controller. The plurality of physical CPUs each includes a plurality of CPU cores. The controller performs control of selecting two or more CPU cores that are caused to execute an application to be executed using the two or more CPU cores, from one physical CPU of the plurality of physical CPUs.

### CROSS-REFERENCE TO RELATED APPLICATION

This application is based upon and claims the benefit of priority of the prior Japanese Patent Application No. 2024-077644, filed on May 13, 2024, the entire contents of which are incorporated herein by reference.

### FIELD

The embodiments discussed herein are related to an information processing apparatus and an information processing method.

### BACKGROUND

There have been known several techniques of managing allocation of a processing resource to an application to be executed (for example, refer to Japanese Laid-open Patent Publication No. 2022-180850 and Japanese Laid-open Patent Publication No. 2006-244479).

### SUMMARY

According to an aspect of an embodiment, an information processing apparatus includes a plurality of physical CPUs each including a plurality of central processing unit (CPU) cores, and a controller configured to perform control of selecting two or more CPU cores of the plurality of CPU cores that are caused to execute an application to be executed using the two or more CPU cores, from one physical CPU of the plurality of physical CPUs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a physical server;

FIG. 2 is a diagram explaining an example of allocation of a CPU core and deployment of an accelerator to each application included in a complex application that are to be performed by a control unit;

FIG. 3 is a flowchart illustrating processing details of an example of application activation processing;

FIG. 4 is a diagram illustrating a data example of a group registration table;

FIG. 5 is a flowchart illustrating processing details of an example of CPU core allocation processing;

FIG. 6 is a diagram illustrating a data example of a CPU information table;

FIG. 7 is a diagram illustrating a data example of a CPU usage rate table;

FIG. 8 is a flowchart illustrating processing details of an example of deploy request processing; and

FIG. 9 is a flowchart illustrating processing details of an example of deploy request processing;

FIG. 10 is a diagram illustrating a data example of an accelerator information table and a number-of-standby-accelerators table.

### DESCRIPTION OF EMBODIMENTS

If a complex application including a plurality of applications is executed, data passing sometimes occurs between applications. In an information processing apparatus including a plurality of physical central processing units (CPUs) including a plurality of CPU cores, executing applications included in a complex application, in CPU cores of separate physical CPUs is considered. In this case, data passing between the applications is performed using an inter-CPU bus connecting between the physical CPUs. Thus, if the data passing frequently occurs, a delay in data transfer between physical CPUs occurs due to the bottleneck of the band of the inter-CPU bus, and a processing speed of the complex application processed by the information processing apparatus consequently decreases.

In an information processing apparatus including a plurality of physical CPUs including a plurality of CPU cores, if a complex application being an application including a plurality of applications is executed, data passing between applications sometimes occurs. If applications included in the complex application are executed in CPU cores included in separate physical CPUs, data passing between applications is performed using an inter-CPU bus connecting between the physical CPUs. Thus, if the data passing frequently occurs, a delay in data transfer between physical CPUs sometimes occurs due to the bottleneck of the band of the inter-CPU bus.

Further, an information processing apparatus including an arithmetic device (accelerator) preferable for specific calculation has been known. In such an information processing apparatus, higher processing speed is realized by offloading partial processing in an application that has a slow processing speed by the execution in a general-purpose CPU, to an accelerator.

Further, an information processing apparatus including a number of accelerators called disaggregated computers has been known. In such an information processing apparatus, an orchestrator is sometimes used. The orchestrator performs the management of deployment of each accelerator, for example, and deploys each accelerator included in an information processing apparatus, to an application to be executed on a physical CPU included in the information processing apparatus. At this time, if an accelerator existing under a physical CPU different from a physical CPU that executes an application is deployed to the application, communication for access to the accelerator from the application is performed via an inter-CPU bus. Also in this, a delay sometimes occurs in communication between physical CPUs due to the bottleneck of the band of the inter-CPU bus, and the performance of access from an application to processing offloaded to the accelerator consequently deteriorates in some cases.

Furthermore, also when a complex application including a plurality of applications is executed using such an information processing apparatus, data passing is sometimes performed between applications. At this time, in a case where partial processing in each application included in the complex application is offloaded to an accelerator, data passing sometimes occurs also between accelerators deployed to applications. Here, if accelerators existing under separate physical CPUs are deployed to applications, communication for data passing between accelerators is also performed via an inter-CPU bus. Accordingly, also in this case, a delay occurs in communication between physical CPUs due to the bottleneck of the band of the inter-CPU bus, and it consequently becomes difficult to guarantee execution performance of the complex application in some cases.

In view of the foregoing, in an embodiment to be described from now on, a plurality of applications included in a complex application is executed by each CPU core included in one physical CPU of a plurality of physical CPUs included in an information processing apparatus. With this configuration, it is possible to reduce data passing between applications that goes through an inter-CPU bus (or prevent data passing from going through the inter-CPU), and a decrease in processing speed that is attributed to the band of the inter-CPU bus is accordingly suppressed.

Further, in an embodiment to be described from now on, in the case of offloading partial processing in applications included in the complex application, to an accelerator, an accelerator existing under the one physical CPU is deployed to each application. With this configuration, access to an accelerator from an application and communication for data passing between accelerators are performed without going through an inter-CPU bus, and a decrease in processing speed that is attributed to the band of the inter-CPU bus is accordingly suppressed.

Preferred embodiments will be explained with reference to accompanying drawings.

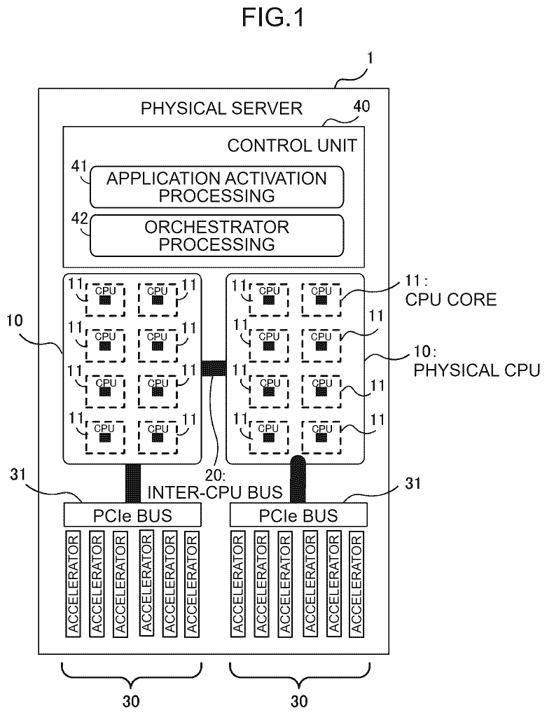

FIG. 1 illustrates a configuration example of a physical server 1. The physical server 1 is an example of an information processing apparatus.

The physical server 1 includes a plurality of physical CPUs 10 each including a plurality of CPU cores 11. In the configuration example illustrated in FIG. 1, the physical server 1 include two physical CPUs 10 each including eight CPU cores 11, but both of the number of physical CPUs 10 included in the physical server 1 and the number of CPU cores 11 included in each physical CPU 10 need not be the numbers illustrated in FIG. 1.

In the physical server 1, the physical CPUs 10 are connected one-on-one by an inter-CPU bus 20. The inter-CPU bus 20 is a data transmission path between the physical CPUs 10, and is, for example, QuickPath Interconnect (QPI) or Ultra Path Interface (UPI).

Further, the physical server 1 includes a plurality of accelerators 30, and a plurality of accelerator 30 is connected to each of the plurality of physical CPUs 10 by a PCIe bus 31. The PCIe bus 31 is a data transmission path complying with the Peripheral Component Interconnect-Express (PCIe) standard, but the physical CPUs 10 and the accelerators 30 may be connected in compliance with another standard.

In addition, in the present application, an accelerator 30 that can perform data transmission with a physical CPU 10 via such an interface without going through another physical CPU 10 will be referred to as an accelerator 30 existing under the physical CPU 10.

Further, in the configuration example in FIG. 1, each physical CPU 10 includes six accelerator 30 existing thereunder, but the number of accelerators 30 existing under each physical CPU 10 is not limited to the number illustrated in FIG. 1.

The physical server 1 illustrated in FIG. 1 further includes a control unit 40 that controls each component of the physical server 1. The control unit 40 may be formed by any CPU core 11 included in the physical CPU 10 included in the physical server 1, executing a predetermined control program, for example. In the present embodiment, control processing to be executed by the control unit 40 includes application activation processing 41 and orchestrator processing 42.

The application activation processing 41 is processing of allocating, to an application included in a complex application, a CPU core 11 that executes the application, when the complex application is executed in the physical server 1. Nevertheless, in the present embodiment, the application activation processing 41 selects a CPU core 11 to be allocated to each application included in the complex application to be executed using two or more CPU cores 11, from one of a plurality of physical CPUs 10 of the physical server 1.

The orchestrator processing 42 is processing for providing a function as an orchestrator. In the present embodiment, in response to a request for deployment of the accelerator 30, the orchestrator processing 42 deploys an accelerator 30 existing under the physical CPU 10 including the CPU core 11 allocated to the application, to a request source application of the request.

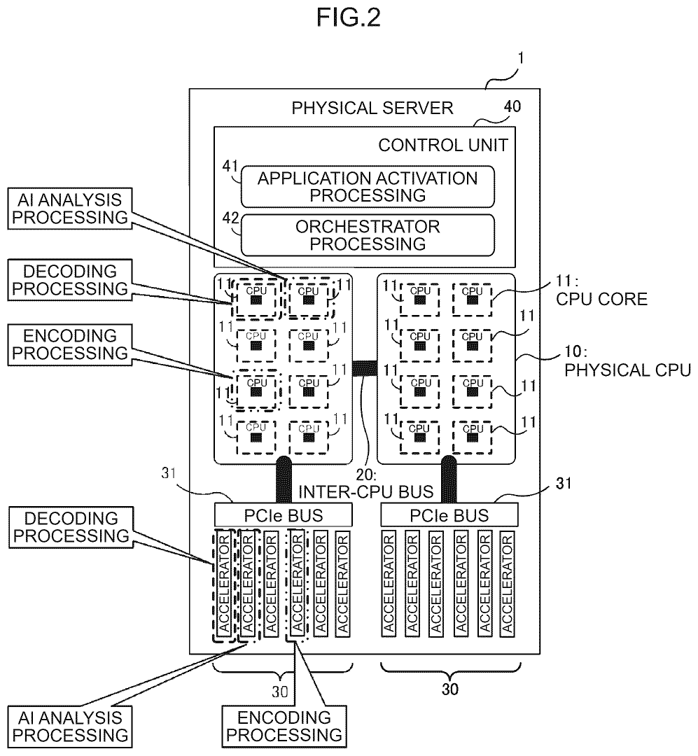

Here, an example of the allocation of the CPU core 11 and deployment of the accelerator 30 to each application included in a complex application that are to be performed by the control unit 40 will be described with reference to FIG. 2.

Here, an example of a case of executing an application of performing video analysis processing, in the physical server 1 will be described. In addition, the application that performs the video analysis processing is a complex application including three applications for respectively performing decoding processing, AI analysis processing, and encoding processing. In addition, the “AI” stands for Artificial Intelligence. Further, each of the three applications provides a part of its function by offload processing to be performed using one accelerator 30.

In this case, first of all, the application activation processing 41 groups the above-described three applications included in the complex application that performs the video analysis processing, as one group. Next, at the time of activation of each application, the application activation processing 41 allocates, to applications in the same group, one CPU core 11 selected from among a plurality of CPU cores 11 included in one physical CPU 10 of a plurality of physical CPUs 10. In the present embodiment, the application activation processing 41 refers to the respective CPU usage rates of the plurality of CPU cores 11 included in one physical CPU 10, selects CPU cores 11 in ascending order of CPU usage rates, and allocates the selected CPU cores 11 to applications. In addition, for the allocation of a CPU core 11 to an application, for example, a CPU affinity function to be provided by an operating system (OS) of the physical server 1 is used.

FIG. 2 illustrates a state in which three applications corresponding to decoding processing, AI analysis processing, and encoding processing are allocated by the application activation processing 41 to three CPU cores 11 included in a left-side physical CPU 10 included in the physical server 1.

Next, the orchestrator processing 42 acquires a deploy request of the accelerator 30 from each application in the same group. The deploy request includes information regarding the number of the accelerators 30 needed by a request source application of the deploy request for offload processing. The orchestrator processing 42 calculates the total of number of needed accelerators 30 that are included in deploy requests from applications in the same group. Further, the orchestrator processing 42 acquires the number of the accelerators 30 in a standby state among the accelerator 30 existing under the physical CPUs 10 including the CPU cores 11 allocated by the application activation processing 41 to the applications in the same group. Then, in a case where the total value of the above-described needed numbers is equal to or smaller than the acquired number of the accelerators 30 in the standby state, the orchestrator processing 42 deploys the needed number of the accelerators 30 in the standby state to request source applications of the deploy request.

FIG. 2 illustrates a state in which the three accelerators 30 are respectively deployed by the orchestrator processing 42 to the three applications corresponding to the decoding processing, AI analysis processing, and encoding processing. Further, it is indicated that all of these three deployed accelerators 30 are the accelerators 30 existing under the left-side physical CPU 10 including the CPU cores 11 respectively allocated to the three applications.

Hereinafter, the application activation processing 41, and the orchestrator processing 42, and processing of issuing a request to deploy the accelerator 30 that is to be performed in each application will be further described.

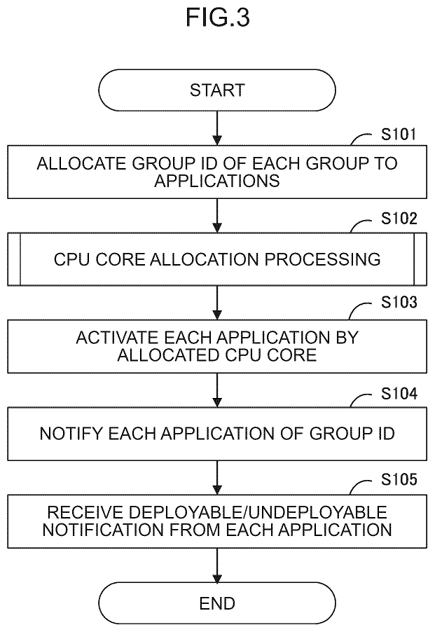

First of all, processing details of an example of the application activation processing 41 will be described with reference to a flowchart in FIG. 3.

If the processing in FIG. 3 is started, first of all, in S101, processing of grouping applications as one group by allocating the same group ID (Identification) to the applications included in the complex application is performed.

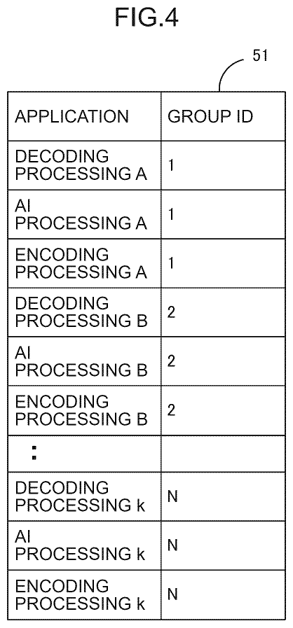

FIG. 4 illustrates a data example of a group registration table 51. The group registration table 51 is a table associating an “application name” and a “group ID”. The “application name” is a name for identifying each application included in the complex application, and the “group ID” is a group ID allocated to each application by the processing in S101.

For example, in the data example in FIG. 4, in records on first to third rows, the same group ID “1” is allocated to three applications corresponding to “decoding processing A”, “AI processing A”, and “encoding processing A” that are included in certain video analysis processing. Accordingly, by data of these records, it can be seen that the three applications of “decoding processing A”, “AI processing A”, and “encoding processing A” are grouped as one group.

In addition, in the present embodiment, information indicating a relationship between a complex application and applications included in the complex application is preliminarily given to the physical server 1.

The description will return to FIG. 3. Next, in S102, CPU core allocation processing is performed. The CPU core allocation processing is processing of selecting one CPU core 11 from among a plurality of CPU cores 11 included in one physical CPU 10, as a CPU core 11 that executes applications included in the same group, and allocating the one CPU core 11, and the details thereof will be described later.

Next, in S103, processing of activating each application by a CPU core 11 following an allocation result obtained by the processing in S102 is performed.

Next, in S104, processing of notifying each application activated by the processing in S103, of the group ID by the processing in S101 is performed.

Next, in S105, processing of receiving, from each application, a deployable/undeployable notification indicating a result of deployment of the accelerator 30 by the orchestrator processing 42 to be described later is performed. In a case where the notification indicates that the accelerator 30 has not been deployed, for example, the deployable/undeployable notification may be used to select a CPU core 11 that is caused to execute each application in subsequent processing, from a different physical CPU 10.

After the processing in S105 is ended, the application activation processing 41 is ended.

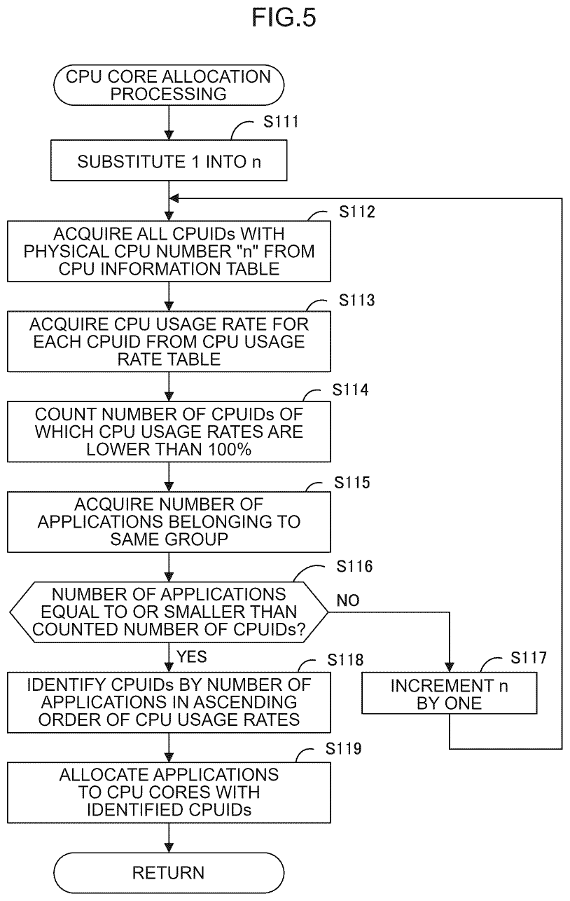

Next, processing details of an example of the CPU core allocation processing being processing in S102 of FIG. 3 will be described with reference to a flowchart in FIG. 5.

If processing in FIG. 5 is started, first of all, in S111, processing of substituting a default value “1” into a variable n is performed.

Next, in S112, referring to a CPU information table 52, processing of acquiring “CPUID” in each record in which a value of a variable n is indicated as a “physical CPU number” is performed.

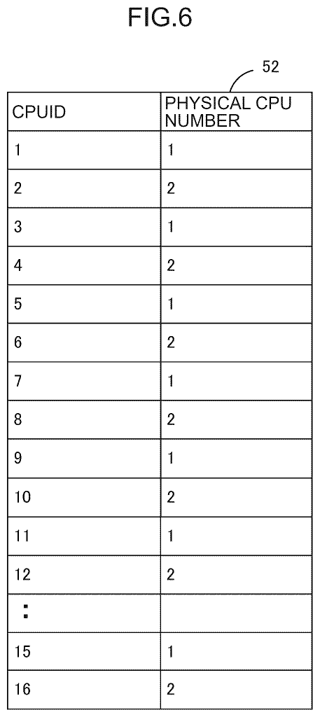

FIG. 6 illustrates a data example of the CPU information table 52. The CPU information table 52 is a table associating a “CPUID” and a “physical CPU number”. The “CPUID” is identification information for identifying CPU cores 11 included in a plurality of physical CPUs 10 included in the physical server 1, and the “physical CPU number” is number information for identifying a physical CPU 10 including the CPU cores 11 identified by the “CPUID”. In the present embodiment, the physical server 1, a CPUID of each CPU core 11 and a physical CPU number of each physical CPU 10 are predetermined, and the CPU information table 52 is prepared in advance.

By the data example in FIG. 6, it can be seen that all CPU cores 11 of which CPUIDs are “1”, “3”, “5”, “7”, “9”, “11”, . . . , and “15” are CPU cores 11 included in a physical CPU 10 of which a physical CPU number is “1”. Further, it can be seen that all CPU cores 11 of which CPUIDs are “2”, “4”, “6”, “8”, “10”, “12”, . . . , and “16” are CPU cores 11 included in a physical CPU 10 of which a physical CPU number is “2”.

In the case of the data example in FIG. 6, in a case where the processing in S112 of FIG. 5 is executed next to the processing in S111, “1”, “3”, “5”, “7”, “9”, “11”, . . . “15” being CPUIDs indicating in records with the physical CPU number of “1” are acquired.

In S113 following S112, processing of acquiring a CPU usage rate of the CPU core 11 to be identified by the CPUID acquired by the processing in S112, from a CPU usage rate table 53 is performed.

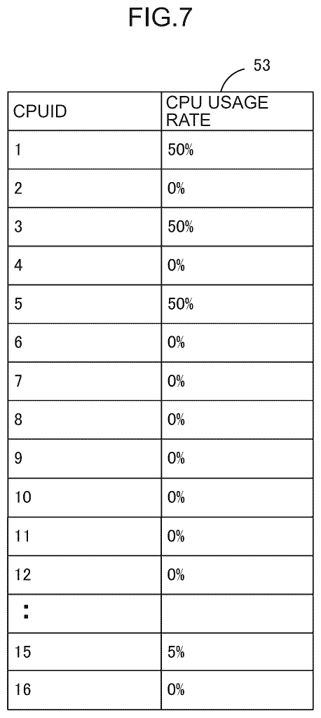

FIG. 7 illustrates a data example of the CPU usage rate table 53. The CPU usage rate table 53 is a table in which a CPU usage rate of a CPU core 11 to be identified by the CPUID is indicated, and is a table associating the CPUID and the CPU usage rate. In addition, in the present embodiment, the OS of the physical server 1 acquires a CPU usage rate of a CPU core 11 and creates the CPU usage rate table 53.

In S114 following S113, processing of counting the number of CPUIDs of which CPU usage rates associated with the CPUIDs in the CPU usage rate table 53 are lower than 100%, among CPUIDs acquired in the processing in S113 is performed. The processing is processing performed to exclude a CPU core 11 of which a CPU usage rate has reached 100%, from a CPU core 11 that is caused to execute an application.

Next, in S115, processing of counting and acquiring the number of applications belonging to the same group by the grouping executed by the processing in S101 of FIG. 3 (i.e., the number of applications to which the same group ID is allocated) is performed.

Because the applications to which “1”, for example, is allocated as a group ID in the data example of the group registration table 51 in FIG. 4 are three applications corresponding to “decoding processing A”, “AI processing A”, and “encoding processing A”, counted value obtained by the processing in S115 is “3”.

Next, in S116, processing of determining whether the number of applications acquired by the processing in S115 is equal to or smaller than the number of CPUIDs counted by the processing in S114 is performed. In the determination processing, when it is determined that the number of applications is equal to or smaller than the number of CPUIDs (when a determination result is YES), the processing proceeds to S118. On the other hand, in the determination processing, when it is determined that the number of applications is larger than the number of CPUIDs (when a determination result is NO), the processing proceeds to S117.

The processing in S117 is processing to be performed in a case where it is determined that it is impossible to execute applications belonging to the same group, only CPU cores 11 included in a physical CPU 10 corresponding to a physical CPU number of a value of the variable n at the processing time point. In this S117, processing of incrementing a value of the variable n (increasing the value by “1”) is performed. Then, after that, the processing returns to S112, and subsequently, processing of determining whether it is possible to execute all applications belonging to the same group, only by CPU cores 11 included in a different physical CPU 10 is performed anew.

On the other hand, in S118, processing of identifying an equal number of CPUIDs to the number of applications acquired by the processing in S115, from the CPUIDs acquired by the processing in S112, in ascending order of CPU usage rates acquired by the processing in S113 is performed.

In the data example of the CPU usage rate table 53 in FIG. 7, as for three CPU cores 11 of which CPUIDs are “7”, “9”, and “11”, all CPU usage rates are “0” (%), which is the lowest. Accordingly, in a case where the number of applications acquired by the processing in S115 is “3”, “7”, “9”, and “11” are identified by the processing in S118.

In addition, in a case where the CPU usage rate table 53 of this case includes four or more CPUIDs of which CPU usage rates are “0” (%), for example, three CPUIDs among the CPUIDs are identified. A method of selecting CPUIDs to be identified at this time may be any method, and for example, in a case where a CPUID is a number, CPUIDs may be identified in ascending order of the number.

Next, in S119, processing of allocating the CPU core 11 identified by the CPUID identified by the processing in S118, to applications belonging to the same group, to which the same group ID is allocated is performed.

If the processing in S119 ends, the CPU core

allocation processing in FIG. 5 ends, and after that, the processing returns to the flowchart in FIG. 3, and the processing in S103 and later is performed.

By the above-described CPU core allocation processing being performed, as a CPU core 11 that executes each application included in the complex application, any of a plurality of CPU cores 11 included in one physical CPU 10 is allocated.

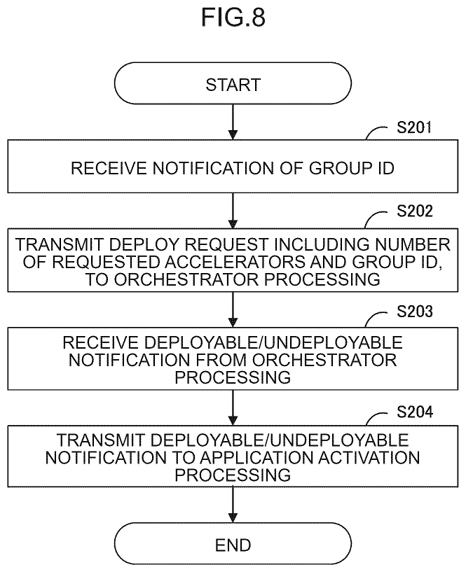

Next, deploy request processing will be described. FIG. 8 is a flowchart illustrating processing details of an example of deploy request processing.

The deploy request processing is processing in which an application requests the orchestrator processing 42 to deploy the accelerator 30 to which a partial processing in the application is to be offloaded, and receives a deployable/undeployable notification indicating a result of the deployment. The deploy request processing is performed when each application is executed and activated by the CPU core 11 allocated by the processing in S103 in the application activation processing 41 illustrated in FIG. 3.

If the processing in FIG. 8 is started, first of all, in S201, processing of receiving the group ID notified from the application activation processing 41 by the processing in S104 of FIG. 3 is performed.

Next, in S202, processing of transmitting a deploy request of the accelerator 30 to the orchestrator processing 42 is performed. The deploy request includes the number of requested accelerators, and information regarding the group ID received by the processing in S201. In addition, the number of requested accelerators is the number of the accelerators 30 to be used to offload partial processing to be executed by the request source application of the deploy request. In the present embodiment, the number of requested accelerators is preset in the request source application.

Next, in S203, processing of receiving a deployable/undeployable notification including a result of deployment of the accelerator 30 performed in response to the deploy request that is notified from the orchestrator processing 42 as a response to the deploy request transmitted by the processing in S201 is performed.

Next, in S204, processing of transmitting the deployable/undeployable notification received by the processing in S203, to the application activation processing 41 is performed. The deployable/undeployable notification transmitted by the processing is received by the processing in S105 in the application activation processing 41 illustrated in FIG. 3.

If the processing in S204 ends, the deploy request processing ends.

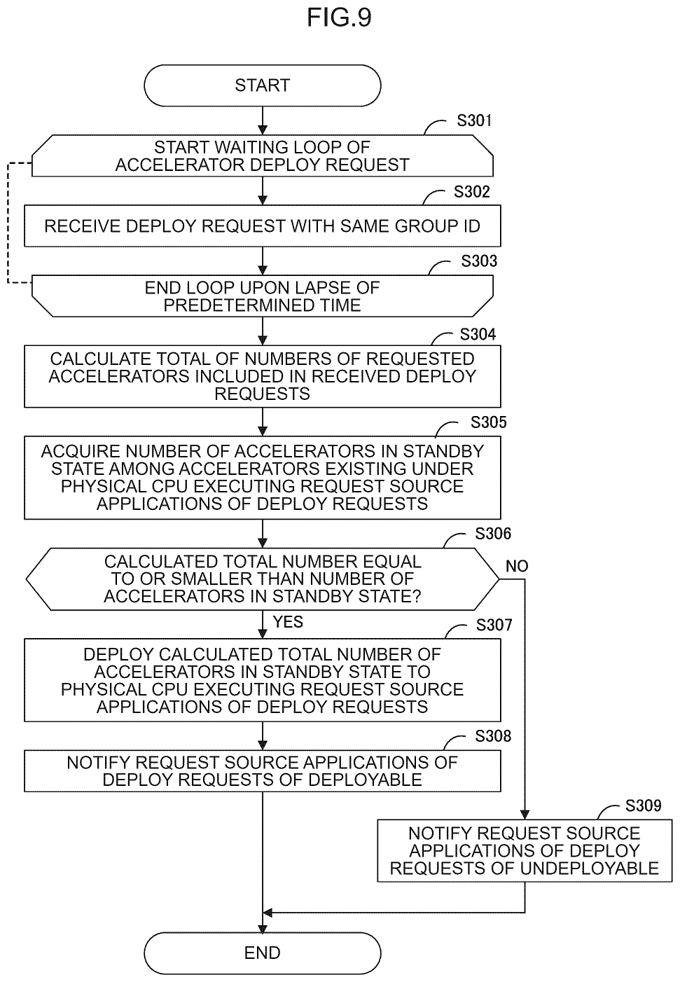

Next, an example of the orchestrator processing 42 will be described with reference to a flowchart in FIG. 9.

The flowchart in FIG. 9 is started if a deploy request transmitted by the execution of the processing in S202 in the deploy request processing in FIG. 8 by any of a plurality of applications included in the complex application is received.

If the processing in FIG. 9 is started, first of all, a loop of processing from S301 to S303 is started. The loop of the processing is continued until a predetermined time elapses since the processing is started. Then, as processing in S302 in the loop of the processing, processing of receiving a deploy request transmitted from a different application having the same group ID as the deploy request that has triggered the start of the orchestrator processing 42 is performed. In the present embodiment, by the loop of the processing, the reception of deploy requests transmitted from all applications having the same group ID (i.e., all applications included in the complex application) is completed.

If the above-described loop of the processing ends, next, in S304, processing of calculating a total value of the numbers of requested accelerators of the applications that are included in the deploy requests having the same group ID, and acquiring the total value is performed. The total value to be acquired by the processing is information regarding the number of the accelerators 30 to be used in the execution of the complex application including the applications.

Next, in S305, processing of acquiring the number of the accelerators 30 in the standby state that exist under the physical CPU 10 including all CPU cores 11 that are executing request source applications of the deploy requests having the same group ID is performed.

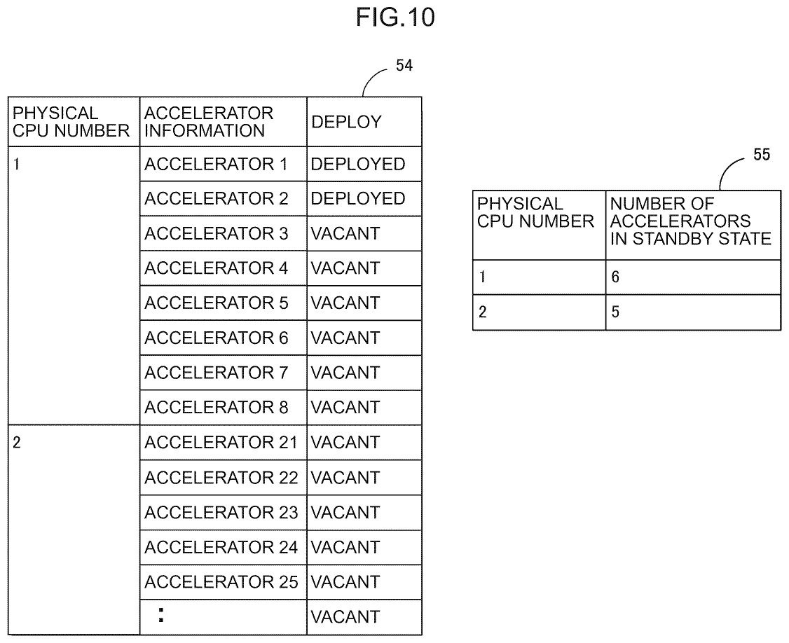

In the present embodiment, the control unit 40 that executes the orchestrator processing 42 performs the management of the states of the accelerators 30 included in the physical server 1, using an accelerator information table 54 and a number-of-standby-accelerators table 55. FIG. 10 illustrates a data example of the accelerator information table 54 and the number-of-standby-accelerators table 55.

The accelerator information table 54 is a table

associating a “physical CPU number”, “accelerator information”, and “deploy”. The “physical CPU number” is number information for identifying a physical CPU 10 included in the physical server 1, and the same information as that indicated in the CPU information table 52. The “accelerator information” is a name for identifying the accelerator 30 included in the physical server 1, and by the association of the “physical CPU number” and the “accelerator information”, a relationship between physical CPU 10 and the accelerator 30 existing under the physical

CPU 10 is indicated. Further, “deploy” indicates a status of deployment of the accelerator 30 identified by the “accelerator information”. Here, in a case where the accelerator 30 is deployed to any application, data of “deploy” associated with “accelerator information” identifying the accelerator 30 is set to “deployed”. On the other hand, in a case where the accelerator 30 is deployed to none of applications, and is in the standby state, data of “deploy” associated with “accelerator information” identifying the accelerator 30 is set to “vacant”.

Further, the number-of-standby-accelerators table 55 is a table associating a physical CPU number of a physical CPU 10, and the number of the accelerators 30 in the standby state among the accelerators 30 existing under the physical CPU 10.

Referring to the data example of the accelerator information table 54 in FIG. 10, among the accelerators 30 of which the physical CPU number is “1”, the number of the accelerators 30 of which deploy is “vacant” is six. Further, among the accelerators 30 of which the physical CPU number is “2”, the number of the accelerators 30 of which deploy is “vacant” is five. Accordingly, in the number-of-standby-accelerators table 55 in FIG. 10, in a record of which the physical CPU number is “1”, the number of accelerators in the standby state is indicated as “6”, and in a record of which the physical CPU number is “2”, the number of accelerators in the standby state is indicated as “5”.

In the above-described processing in S305 of FIG. 9, by referring to the number-of-standby-accelerators table 55, the number of accelerators 30 in the standby state is acquired.

Next, in S306, processing of determining whether the number of the accelerators 30 to be used in the execution of the complex application that has been calculated by the processing in S304 is equal to or smaller than the number of the accelerators 30 in the standby state that has been acquired in the processing in S305 is performed. In the determination processing, when it is determined that the number of the accelerators 30 to be used is equal to or smaller than the number of the accelerators 30 in the standby state (when a determination result is YES), the processing proceeds to S307. On the other hand, when it is determined that the number of the accelerators 30 to be used is larger than the number of the accelerators 30 in the standby state (when a determination result is NO), the processing proceeds to S309.

In S307, processing of deploying the accelerators 30 in the standby state that exist under the under the physical CPU 10, to the physical CPU 10 in which the execution of request source applications of deploy requests having the same group ID, by the number acquired by the processing in S305 is performed.

Next, in S308, processing of transmitting a deployable/undeployable notification indicating deployable (that deployment has been performed), to the request source applications of the deploy requests having the same group ID is performed, and after that, the orchestrator processing 42 ends.

On the other hand, in S309, processing of transmitting a deployable/undeployable notification indicating undeployable (that deployment has failed to be performed), to the request source applications of the deploy requests having the same group ID is performed, and after that, the orchestrator processing 42 ends.

By the above-described orchestrator processing 42 being performed, only the accelerators 30 existing under a physical CPU 10 including CPU cores 11 executing applications included in the complex application are deployed to the applications.

According to one aspect of the present invention, a decrease in processing speed is suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a plurality of physical CPUs each including a plurality of central processing unit (CPU) cores; and
a controller configured to perform control of selecting two or more CPU cores of the plurality of CPU cores that are caused to execute an application to be executed using the two or more CPU cores, from one physical CPU of the plurality of physical CPUS.

2. The information processing apparatus according to claim 1, wherein the controller selects the two or more CPU cores in ascending order of usage rates from among the plurality of CPU cores included in the one physical CPU.

3. The information processing apparatus according to claim 1,
wherein each of the plurality of physical CPUS includes a plurality of accelerators thereunder, and
wherein the controller selects the accelerator to be used in execution of the application, from among the accelerators included under the one physical CPU.

4. The information processing apparatus according to claim 3, wherein the controller selects the accelerator to be used in execution of the application, from among the accelerators in a standby state among the accelerators included under the one physical CPU.

5. The information processing apparatus according to claim 4, wherein the controller acquires information regarding a number of the accelerators to be used in execution of the application, and in a case where the number is equal to or smaller than the number of the accelerators in the standby state that are included under the one physical CPU, selects the accelerator to be used in execution of the application, from among the accelerators in the standby state.

6. An information processing method to be executed by an information processing apparatus including a plurality of physical CPUs each including a plurality of central processing unit (CPU) cores, the information processing method comprising:
selecting two or more CPU cores of the plurality of CPU cores that are caused to execute an application to be executed using the two or more CPU cores, from one physical CPU of the plurality of physical CPUs; and
executing the application using the selected two or more CPU cores, by processing circuitry.
